(19) United States
(12) Patent Application Publication
(10) Pub. No.: US 2022/0359900 A1
(43) Pub. Date: Nov. 10, 2022

(54) HYBRID O2/H2 REGENERATIVE FUEL CELL SYSTEM

(71) Applicant: Infinity Fuel Cell and Hydrogen, Inc., Windsor, CT (US)

(72) Inventor: William F. Smith, Suffield, CT (US)

(73) Assignee: Infinity Fuel Cell and Hydrogen, Inc., Windsor, CT (US)

(21) Appl. No.: 17/640,635

(22) PCT Filed: Sep. 2, 2020
(86) PCT No.: PCT/US2020/048985

§ 371 Date: Mar. 4, 2022

Related U.S. Application Data
(60) Provisional application No. 62/895,614, filed on Sep. 4, 2019.

(51) Int. Cl. H01M 8/18; H01M 8/04082

(52) U.S. Cl. CPC H01M 8/186; H01M 8/04201; H01M 2250/20

(57) ABSTRACT

A Multi-Mode Regenerative Fuel Cell system comprising a non-flow thru fuel cell operatively coupled to a high or medium pressure electrolyzer; a distributed reactant storage assembly comprising at least one hydrogen storage means and at least one oxygen storage means, said distributed reactant storage assembly operatively coupled to said fuel cell and electrolyzer; a pilot oxygen storage means operatively coupled to said oxygen storage means; a water storage means operatively coupled to said fuel cell and electrolyzer, and an aircraft power load operatively coupled to said fuel cell and electrolyzer.

### BACKGROUND

The present disclosure is directed to Multi-Mode Regenerative Fuel Cell (RFC), Multi-Mode Regenerative Fuel Cell (MMRFC), designed to provide emergency power, supplemental or other and eliminate O2 servicing.

Fuel cells for use aboard commercial transport aircraft have been targeted at many different applications including: primary propulsion for light propeller airplanes; emergency electrical power generation; backup power; use of aircraft fuel to generate reactants; on board water generation; and efficient combined use of heat and electrical power.

A common issue among all of these applications is the source of fuel. A Regenerative Fuel Cell (RFC) addresses this issue by generating and storing its own fuel and can be an attractive option for backup/emergency power as compared to batteries and even Ram Air Turbines (RAT). An RFC can store substantial amounts of energy with a lower marginal (incremental) cost and weight compared to batteries. Also, as compared to the RAT no deployment of an external system is required that introduces additional aerodynamic drag.

While an RFC can solve the fuel issue, and the potential benefit is real, the financial return on investment in this new technology is unproven. Existing technologies are well established for such applications as the RAT and new applications, such as distributed galley power, do not readily adapt to retrofit of existing aircraft reducing the attractiveness to investment.

An ideal early application would provide clear financial and technical benefits for both new and retrofit aircraft applications. Applications to provide electrical power alone seem limited. However, the integration of a system to meet multiple flight requirements offers the opportunity to pay back the investment based on other factors in addition to improved power generation or energy storage.

Glossary

APU Auxiliary Power Unit

A-PWR Advanced Product Water Removal

BOP Balance of Plant

DOD Department of Defense

EAR Export Administration Regulations

FMEA Failure Modes and Effects Analysis

ITAR International Traffic in Arms Regulations

MEA Membrane and Electrode Assembly

MMRFC Multi-Mode Regenerative Fuel Cell

MTBF Mean Time Between Failures

NASA National Aeronautics and Space

Administration

NFT Non-Flow Through

PEM Proton Exchange Membrane

P&ID Piping (or Process) and Instrumentation

Diagram

RFC Regenerative Fuel Cell

RAT Ram Air Turbine

ROI Return on Investment

TIM Technical Interchange Meeting

UAS Unmanned Aerial System

UAV Unmanned Aerial Vehicle

UUV Unmanned Underwater Vehicle

### SUMMARY

A Multi-Mode RFC, MMRFC, designed to provide emergency power and eliminate O2 servicing offers the potential to fulfill the above mentioned requirements.

In accordance with the present disclosure, there is provided a Multi-Mode Regenerative Fuel Cell, MMRFC, as shown at FIG. 1, which can provide, in power mode, backup/emergency power fueled by hydrogen and be able to operate on either pure oxygen or air. This system, in regenerate mode, would also provide high-pressure oxygen to storage for both fuel cell reactant and to eliminate servicing of emergency pilot oxygen. The dual benefit amortizes the investment in the system across two different value propositions and opens a pathway for a retrofit market.

Other details of the hybrid O2/H2 regenerative fuel cell system are set forth in the following detailed description and the accompanying drawings wherein like reference numerals depict like elements.

### BRIEF DESCRIPTION OF THE DRAWINGS

FIG. 1 is a schematic diagram of an exemplary Multi-Mode Regenerative Fuel Cell.

FIG. 2 is an image of exemplary Direct High Pressure Electrolysis Stacks, 1-G design on the left, Zero-G design on the right.

FIG. 3 is a chart of an exemplary zero-gravity compatible direct high-pressure electrolysis stacks operating at 1,000 psi H2 and O2.

FIG. 4 are images of Regenerative Fuel Cell systems.

FIG. 5 includes a set of load profile performance results for exemplary H2/O2 Fuel Cells.

FIG. 6 is a chart illustrating varying electrical storage technologies employed and their comparison to fuel cells.

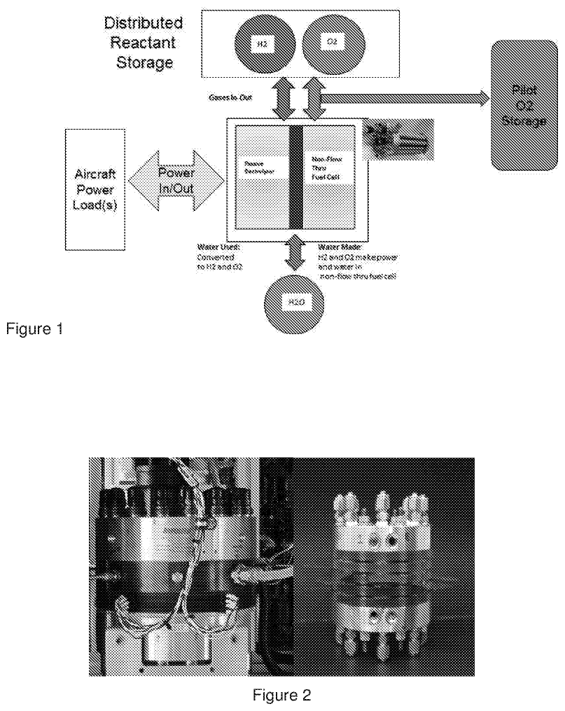

### DETAILED DESCRIPTION

The proposed MMRFC system is a combination emergency power system and an oxygen recharge system that eliminates regular pilot oxygen servicing. It is designed to operate on either H2/O2 or H²/air and can regenerate and store H2 and O2. In normal Power Generation mode, the MMRFC could provide supplemental power operating on H2 and ambient air and when needed switch and operate on H2 and O2 during emergencies. Frequent operation to exercise the system would minimize the need for periodic maintenance testing. Operation on either O2 or air would minimize the amount of stored O2 needed.

The MMRFC is capable of operating in multiple modes of operation; including: Power Generation; Reactant Generation: Recharging H2 and O2 storage; and Pilot oxygen recharge.

Power Generation If the fuel cell were located within the pressurized volume it could operate using ambient air as the source of oxygen with minimal additional compression and thermal insulation and during periods of normal flight. This would allow the system to provide auxiliary or supplemental power to discretionary loads. If the fuel cell were located in the unpressurized volume it would require additional air compression to operate on air and thermal insulation to protect the system from the external environment.

If this system was also an emergency power system it could switch to operate on pure oxygen. For example, to meet a 3-hour ETOPS requirement the MMRFC could operate on stored H2 and O2 at altitudes where a RAT could not be deployed. A 15 kW H2/O2 fuel cell operating on H2/O2 for 3 hours would consume about 2.5 kg of H2 and 20 kg O2 reactant. If only required to operate for 20 minutes to descend to 8,000 feet and resume air operation at rated power (time to reach 8,000 ft.) it would consume approximately 0.42 kg H2, about 175 SCF and about 3.3 kg O2 or about 88 SCF O2. A standard 114 SCF aircraft O2 bottle stored at 2,000 psi would meet this need.

Reactant Generation In reactant generation mode the MMRFC would utilize the aircraft power bus to generate and store hydrogen and oxygen to replace the reactants consumed. Infinity's high-pressure stack designs can generate and stored hydrogen and oxygen at high pressure without using an external compressor. FIG. 2 illustrates two of Infinity's high-pressure stack designs.

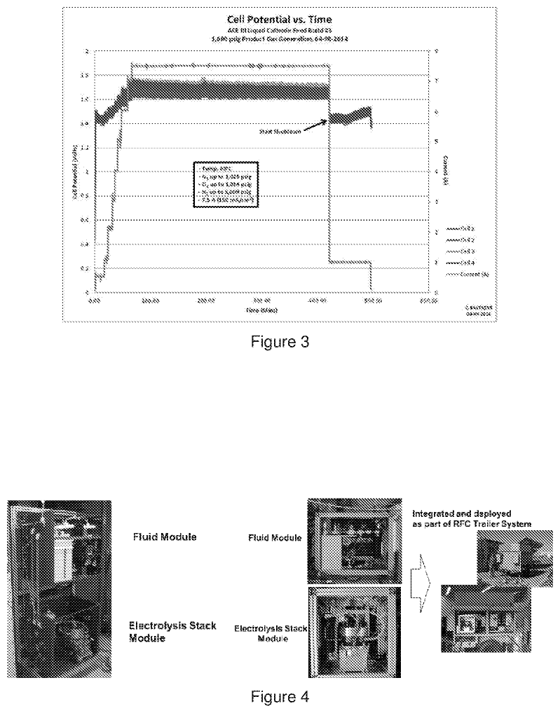

FIG. 3 is a chart of one of Infinity's zero-gravity compatible direct high-pressure electrolysis stacks operating at 1,000 psi H2 and O2.

If the system was only used for emergency power the only oxygen delivered from the system during normal reactant generation operations would be the amount required to recharge the aircraft oxygen system and a small amount to ensure reactants were replaced after periodic maintenance exercises.

The oxygen generation rate to only keep the pilot bottles full is relatively small but elimination of O2 servicing can provide a large benefit. The oxygen recharge benefit is detailed further below.

Regenerative Fuel Cell Background

FIG. 4 illustrates three generations of Regenerative Fuel Cell systems delivered to the government by Infinity Fuel Cell. These systems included controls, high-pressure electrolysis stacks, fuel cell stack(s), 2000 psi integrated H2 storage, and thermal control and were demonstrated in ground field trials.

Also, Infinity developed and tested three phases of NASA high-pressure (2000 psi), lightweight electrolysis-based oxygen/hydrogen generation systems compatible with zero gravity.

Through this Regenerative Fuel Cell work, Infinity has developed the fluid-mechanical, controls, electrical and operations designs and processes to meet systems requirements for fully turnkey military systems deployed in the field.

These systems included design for maintainability by partitioning into Line Replaceable Units, (LRUs) that are connected via M38999 type soldered connectors. It included RFID maintenance tags for LRUs and major components. The system RFID reader interrogates the tags for maintenance actions and can upload calibration data. If a calibrated sensor, such as a pressure transducer required replacement the reader can upload the calibration factors from its RFID tag and update the control database.

Regarding safety, reliability and installation, all of these system design efforts included detailed safety hazard analyses that were used as the basis for control design and site approval and certification.

The following patents are incorporated herein by reference as examples of fuel cell technology that Infinity has developed.

“Modular Regenerative Fuel Cell System”, (2011), U.S. Pat. No. 8,003,268 B2, William F. Smith

“Regenerative electrochemical cell system and method for use thereof”, U.S. Pat. No. 7,241,522

“Regenerative electrochemical cell system and method for use thereof”, U.S. Pat. No. 6,887,601

An exemplary preliminary baseline MMRFC design is contemplated with a targeted aircraft and use that as the initial model for installation, maintenance and evaluation. The modular nature of the MMRFC allows packaging of major components to fit available space on the aircraft. For example, high pressure electrolysis module can be designed to fit into a standard location for a pilot oxygen cylinder. Such packaging would utilize existing mounts and brackets and locate the O2 recharge unit adjacent to the oxygen bottle being filled. This is only one example but the modules can be distributed in many locations aboard the aircraft either internal or external to the pressurized volume.

Targeted Aircraft Systems Benefits

The currently envisioned primary value proposition is to eliminate pilot O2 servicing and secondarily to provide backup power in the case of degraded primary power. Additionally, once such a system is proven to be reliable it could augment or replace the RAT function.

Reduced O2 Maintenance

All aircraft that operate above 10,000 feet must provide oxygen to crew and passengers. For commercial transport aircraft this is done by systems that provide a pressurized atmosphere with the cabin at approximately 10.8 psia simulating an altitude of approximately 8000 feet.

Virtually all commercial transport aircraft have gaseous pilot emergency oxygen. Backup O2 is a minimum equipment list (MEL) item and the MEL level for this O2 supply is roughly 80% of full capacity. E.g., full charge at 1850 psi, refill/replace at 1600 psi. Pilots are required to check-breathe O2 on every takeoff and while the amount of O2 lost in each check is small, the checks are frequent. The result is that after about 2 weeks the bottles must be refilled/replaced. This must be done for all aircraft in each commercial transport fleet for all such fleets in the world. Overall O2 maintenance is one of the most frequent operations airline maintenance actions and must be performed by highly trained technicians.

RAT Replacement

As noted in the recent Aviation Rulemaking Committee (ARC) report, the emergency power system provides power for the essential loads when both the normal sources of electrical power fail (e.g., main engine generators and APU generators). On modern transport category airplanes emergency power is supplied by the Ram Air Turbine (RAT).

Replacement of the RAT with an MMRFC projects to provide the following benefits: altitude independence: operation for extended periods unlimited by O2 partial pressure or airspeed; elimination RAT aerodynamic drag increasing glide time; able to be at full power within milliseconds; can be turned on and off (the RAT cannot be retracted); in flight readiness checks; increased safety: no external rotating components.

Some RAT's cannot be deployed at altitude due to the mechanical load on the aircraft and so the aircraft reduces its altitude to around 25,000 feet before deploying. This shortens the glide time if thrust has also been lost. At low air speeds the RAT usually become ineffective so the function is taken over by batteries (e.g., on landing approach).

The hydrogen supplied can be derived from a pressurized type 3 tank that can be recharged by the MMRFC, supplemented by solid hydrogen fuel store. The supplemental solid hydrogen storage, such as provided by our underwater customer General Atomics, has the advantage of containing the hydrogen in an inert state over an extended period of time and only requires a low-pressure supporting system.

The oxidant can be provided by a high-pressure tank that is refilled by the MMRFC.

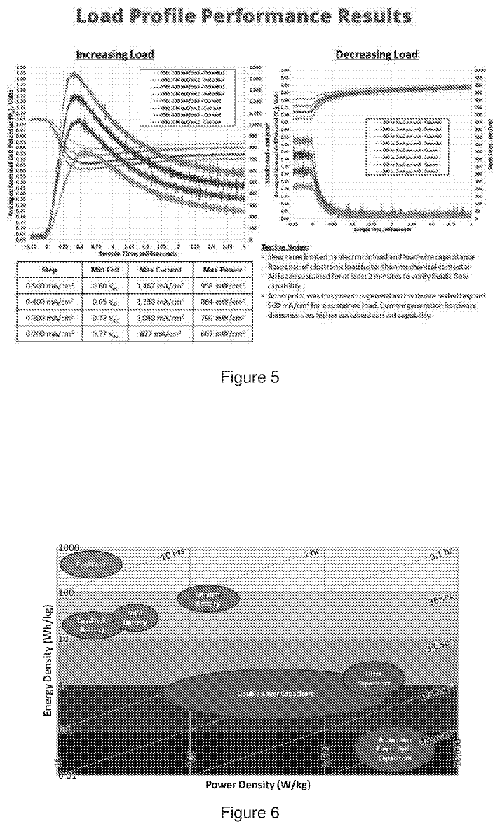

The MMRFC will be kept at hot standby in flight. Once in standby, the time to operational state is on the order of a few milliseconds, FIG. 5, much less than of the deployment of the RAT and can either be executed under pilot control or automatically.

Compared to the RAT, the fuel cell system will be able to operate at much higher altitudes and provides power continuously at any altitude leading to a longer glide time.

A further advantage is that the fuel cell system can be turned off (and restarted if required), the RAT however, cannot be retracted once deployed so it will continue to disrupt the aerodynamics of the aircraft.

The fuel cell system can be exercised periodically, both in flight using a small quantity of the stored hydrogen, or on the ground using an auxiliary supply, whereas the RAT requires downtime to test/maintain the system which, to some operators, may be a significant inconvenience.

Supplemental Increased Electrical Energy Storage

In addition to the benefit of RAT replacement another benefit can be the provision of additional electrical energy storage that can be used to supplement other backup in non-emergency applications. The chart shown in Error! Reference source not found.6 illustrates varying electrical storage technologies employed and their comparison to fuel cells.

Certification Approach

Perhaps the single greatest risk factor to the application of fuel cells to commercial transport aircraft is commercial viability. This in-turn is driven by the “problem” solved and the benefit provided since it is fundamental that any new technology must earn its way aboard the aircraft. An issue for fuel cells is that while there are many electrical power/energy potential applications aboard current generation commercial aircraft none of these have currently risen to a level where fuel cells clearly provide the preferred solution.

The proposed MMRFC solution addresses this risk by combining the energy storage capability with the pilot oxygen recharge capability. In previous marketing experience with Boeing and Airbus a system that eliminated regular servicing of pilot oxygen servicing was seen as a major advance with potential for implementation on new aircraft and as a retrofit system. The system may be able to justify much of its cost by the oxygen savings alone.

There has been provided a hybrid O2/H2 regenerative fuel cell system. While the hybrid O2/H2 regenerative fuel cell system has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A Multi-Mode Regenerative Fuel Cell system comprising:
a fuel cell operatively coupled to a high pressure electrolyzer;
a distributed reactant storage assembly comprising at least one hydrogen storage means and at least one oxygen storage means, said distributed reactant storage assembly operatively coupled to said fuel cell and electrolyzer;
a pilot oxygen storage means operatively coupled to said oxygen storage means;
a water storage means operatively coupled to said fuel cell and electrolyzer, and
an aircraft power load operatively coupled to said fuel cell and electrolyzer.

2. The Multi-Mode Regenerative Fuel Cell system according to claim 1, wherein said Multi-Mode Regenerative Fuel Cell system is configured to backup/emergency power fueled by hydrogen and operating on at least one of air or pure oxygen.

3. The Multi-Mode Regenerative Fuel Cell system according to claim 1, wherein said Multi-Mode Regenerative Fuel Cell system is configured to provide high-pressure oxygen to said at least one oxygen storage means and said pilot oxygen storage means.

4. The Multi-Mode Regenerative Fuel Cell system according to claim 1, wherein said Multi-Mode Regenerative Fuel Cell system is configured to operate in a regenerate mode.

5. The Multi-Mode Regenerative Fuel Cell system according to claim 1, wherein said Multi-Mode Regenerative Fuel Cell system is configured to eliminate servicing said pilot oxygen storage means.

6. The Multi-Mode Regenerative Fuel Cell system according to claim 1, wherein said Multi-Mode Regenerative Fuel Cell system is configured to operate utilizing ambient air during period of normal flight.

7. The Multi-Mode Regenerative Fuel Cell system according to claim 1, wherein said Multi-Mode Regenerative Fuel Cell system is configured to operate on pure oxygen and hydrogen at altitudes in the absence of a ram air turbine.

8. The Multi-Mode Regenerative Fuel Cell system according to claim 1, wherein said Multi-Mode Regenerative Fuel Cell system is configured to operate in a reactant generation mode to generate and store hydrogen and oxygen in the absence of an external compressor.

9. The Multi-Mode Regenerative Fuel Cell system according to claim 1, wherein said Multi-Mode Regenerative Fuel Cell system is configured to recharge the at least one oxygen storage means and pilot oxygen storage means.
